(19) United States
(12) Patent Application Publication
(10) Pub. No.: US 2014/0149954 A1
(43) Pub. Date: May 29, 2014

(54) STRESS EFFECT MODEL OPTIMIZATION IN INTEGRATED CIRCUIT SPICE MODEL

(71) Applicant: Semiconductor Manufacturing International Corporation (Shanghai), Shanghai (CN)

(72) Inventor: Hua Xiang YIN, Shanghai (CN)

(21) Appl. No.: 13/943,670

(22) Filed: Jul. 16, 2013

(30) Foreign Application Priority Data
Nov. 23, 2012 (CN) 201210480135.3

(51) Int. Cl. G06F 17/50

(52) U.S. Cl. CPC G06F 17/5081
USPC 716/112

(57) ABSTRACT

A method and apparatus for stress effect model optimization in IC SPICE model and an IC fabrication method are disclosed. The method for optimizing a stress effect model in an integrated circuit model including obtaining values of at least one layout parameter for a plurality of layout areas in an integrated circuit layout; obtaining values of at least one processing parameter for a plurality of wafer areas corresponding to the layout areas; based on the obtained values of the layout parameter and the obtained values of the process parameter, establishing a function representative of dependency of the process parameter on the layout parameter; and applying the function as a process model parameter to the stress effect model.

### CROSS-REFERENCE TO RELATED APPLICATIONS

This application claims priority to Chinese Patent Application No. 201210480135.3, filed on Nov. 23, 2012 and entitled “STRESS EFFECT MODEL OPTIMIZATION IN INTEGRATED CIRCUIT SPICE MODEL”, which is incorporated herein by reference in its entirety.

### BACKGROUND

1. Field of the Invention

The disclosure generally relates to integrated circuit (IC) design and fabrication, and more specifically, to optimization of a stress effect model in the IC SPICE model.

2. Description of the Related Art

With the development of IC techniques, stress that may occur within the structure of the IC has been widely researched and applied as a factor that can influence transistor performance. Stress applied within transistors can be from many sources, such as shallow trench isolation (STI), source/drain embedded SiGe (eSiGe), silicide, replacement gate, etc. These stresses have a significant effect on the carrier mobility, threshold voltage and other parameters (such as, DIBL (Drain Induced Barrier Lowering), saturation velocity) of the IC. Therefore, when designing an IC, the effect of stress within the IC has to be considered.

IC modelling and simulation have become indispensable tools for IC design and fabrication. SPICE (Simulation Program with Integrated Circuit Emphasis) is the most popular simulation program, from which various versions of SPICE simulation tools have been derived, all employing SPICE simulation algorithms initially developed by the University of California, Berkeley. As semiconductor techniques are further developed, more and more models and parameters are being incorporated into SPICE to simulate newly emerged effects.

The BSIM4 model of SPICE includes a stress effect model, in which the effect of stress on transistor performance is considered. More particularly, in the BSIM4 model, the effect of stress that is induced by processes is incorporated into design modelling of the active area size, the device location, and other layout parameters. Therefore, in the BSIM4 stress effect model, the influence of layout parameters on carrier mobility, threshold voltage, and other transistor parameters under a given process condition is evaluated to characterize the effect of stress on transistor performance. FIG. 1 shows a schematic diagram of a SPICE model 100 with the stress effect model in the prior art, in which a layout-dependent stress effect model 120 is incorporated as a supplement on the basis of the core SPICE model 110, so as to take the effect of stress on device performance into account. As an example, the stress effect model 120 may include a carrier mobility related model 130 and a threshold voltage related model 140.

However, the existing stress effect model cannot precisely characterize the effect of stress on transistor performance, and thus there is a need for an enhanced stress effect model in the SPICE model.

### SUMMARY

According to one aspect, a method for optimizing a stress effect model in an integrated circuit model is provided. The method including: obtaining values of at least one layout parameter for a plurality of layout areas in an integrated circuit layout; obtaining values of at least one processing parameter for a plurality of wafer areas corresponding to the layout areas; based on the obtained values of the layout parameter and the obtained values of the process parameter, establishing a function representative of dependency of the process parameter on the layout parameter; and applying the function as a process model parameter to the stress effect model.

The function may be a semi-logarithmic function or a linear function, and the function is established by fitting the obtained values of the layout parameter for the plurality of layout areas and the values of the process parameter for the plurality of wafer areas.

The process parameter may be a process parameter involved in a process for applying stress to a transistor.

The process parameter may be a process parameter related to an eSiGe process.

The process parameter may include at least one of: Ge content of the eSiGe, depth of a source/drain recess, volume of the eSiGe, SiGe growth rate, and thickness of the epitaxial SiGe film.

The layout parameter may include Si coverage, which is defined as, in a given layout area, a ratio of an area where Si is exposed to the given layout area.

The values of the layout parameter may be extracted from a physical layout pattern and the values of the process parameter are measured using a process monitoring tool from a wafer corresponding to the physical layout pattern.

The at least one process parameter may include a plurality of process parameters, and establishing the function may include: for each process parameter, establishing a sub-function representative of dependency of the process parameter on the layout parameter, and combining the sub-functions for the plurality of process parameters to obtain the function.

The transistor parameter may include at least one of carrier mobility and threshold voltage, and in the case that the transistor parameter comprises the carrier mobility, the process model parameter comprises KU0; in the case that the transistor parameter comprises the threshold voltage, the process model parameter comprises KVTH0, STK2 and STETA0, wherein: KU0 is a basic carrier mobility enhancement coefficient for stress effect, KVTH0 is a VTH shift coefficient for stress effect, STK2 is a K2 shift factor related to VTH0 change, STETA0 is an ETA0 shift factor related to VTH0 change, wherein VTH is a transistor threshold voltage, VTH0 is a threshold voltage at zero substrate bias, K2 is a second-order body bias coefficient, ETA0 is a drain induced barrier lowering (DIBL) coefficient in subthreshold region.

According to another aspect, a system for optimizing a stress effect model in an integrated circuit (IC) model is provided. The system including: a processor; a memory configured to store instructions for controlling the processor, the instructions including obtaining values of at least one layout parameter for a plurality of layout areas in a layout of an integrated circuit; obtaining values of at least one process parameter for a plurality of wafer areas corresponding to the layout area; based on the obtained values of the layout parameter and the obtained values of the process parameter, establishing a function representative of dependency of the process parameter on the layout parameter; and applying the function as a process model parameter to the stress effect model.

The function may be a semi-logarithmic function or a linear function, and the function is established through fitting the obtained values of the layout parameter for the plurality of layout areas and the values of the process parameter for the plurality of wafer areas.

The process parameter may be a process parameter involved in a process for applying stress to a transistor.

The process parameter may be a process parameter related to an eSiGe process.

The process parameter may include at least one of: Ge content of the eSiGe, depth of source/drain recess, volume of the eSiGe, SiGe growth rate, and thickness of the epitaxial SiGe film.

The layout parameter may include Si coverage, which is defined as, in a given layout area, a ratio of an area where Si is exposed to the given layout area.

The values of the layout parameter may be extracted from a physical layout pattern and the values of the process parameter may be measured using a process monitoring tool from a wafer corresponding to the physical layout pattern.

The at least one process parameter may include a plurality of process parameters, and the instructions for establishing the function may include: instructions for, for each process parameter, establishing a sub-function representative of dependency of the process parameter on the layout parameter, and instructions for combining the sub-functions for the plurality of process parameters to obtain the function.

The transistor parameter may include at least one of carrier mobility and threshold voltage, and in the case that the transistor parameter includes the carrier mobility, the process model parameter may include KU0; in the case that the transistor parameter may include the threshold voltage, the process model parameter may include KVTH0, STK2 and STETA0, wherein: KU0 is a basic carrier mobility enhancement coefficient for stress effect, KVTH0 is a VTH shift coefficient for stress effect, STK2 is a K2 shift factor related to VTH0 change, STETA0 is an ETA0 shift factor related to VTH0 change, wherein VTH is a transistor threshold voltage, VTH0 is a threshold voltage at zero substrate bias, K2 is a second-order body bias coefficient, ETA0 is a DIBL coefficient in subthreshold region.

According to a yet aspect, an integrated circuit (IC) fabrication method is provided, including: using the provided method for optimizing a stress effect model in an integrated circuit model; incorporating the optimized stress effect model into the SPICE model; and fabricating an integrated circuit based on simulation results of the SPICE model.

With the optimized SPICE model of the present disclosure, the effect of stress in an actual integrated circuit can be accurately reflected, so as to better simulate semiconductor device characteristics, thereby assisting IC design and fabrication.

Other features and advantages will become apparent from the detailed description of exemplary embodiments given below with reference to accompanying drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure, wherein:

FIG. 1 shows a schematic diagram of a SPICE model with a stress effect model in the prior art.

FIG. 2 shows a schematic diagram of a SPICE model with a stress effect model according to an embodiment of this disclosure.

FIG. 3 schematically shows a typical physical layout pattern of a transistor.

FIG. 4 shows a flowchart of a method for optimizing a stress effect model in a SPICE model according to an embodiment of this disclosure.

FIG. 5 shows a flowchart of a method for optimizing a stress effect model of a SPICE model according to a particular example of this disclosure.

FIGS. 6A-6C schematically show the dependency of process parameters on a layout parameter according to an embodiment of this disclosure.

FIG. 7 shows a flowchart of an IC fabrication method according to an embodiment of this disclosure.

### DESCRIPTION OF THE EMBODIMENTS

Various exemplary embodiments will now be described in detail with reference to the drawings. It should be noted that the relative arrangement of the components and steps, the numerical expressions, and numerical values set forth in these embodiments are not intended to limit the scope of the present disclosure unless it is specifically stated otherwise.

It should be appreciated that, for the convenience of description, various parts shown in those drawings are not necessarily drawn on scale.

The following description of at least one exemplary embodiment is merely illustrative in nature and is in no way intended to limit the disclosure, its application, or uses.

Certain techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Similar reference numerals and letters refer to similar items in the following figures, and thus once an item is defined in one figure, it is possible that it need not be further discussed for following figures.

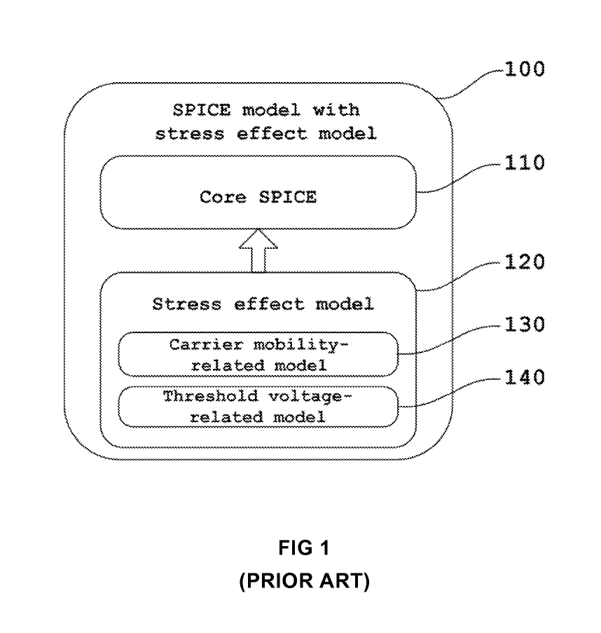

FIG. 1 shows a schematic diagram of a SPICE model with a stress effect model in the prior art. In the stress effect model 120, stress effect on a transistor parameter is evaluated based on layout parameters and at least one process model parameter related to processing. For a given process condition, the process model parameter is a constant value, while the layout parameters depend on the physical layout pattern. Through incorporating the stress effect model 120 into the core SPICE model, the effect of stress on device performance can be taken into account in IC simulation.

Below, a model 130, related to carrier mobility, and a model 140, related to threshold voltage, that are used in the BSIM4 stress effect model 120 will be introduced as an example.

The carrier mobility-related model 130 can be expressed as follows.

$$\begin{matrix}\frac{{μ}_{eff}}{{μ}_{eff 0}} = 1 + {ρ}_{μ eff} & ( 1 ) \\ {ρ}_{μ eff} = \frac{KU 0}{Kstress\_u 0} \cdot ( Inv\_sa + Inv\_sb ) & ( 2 )\end{matrix}$$

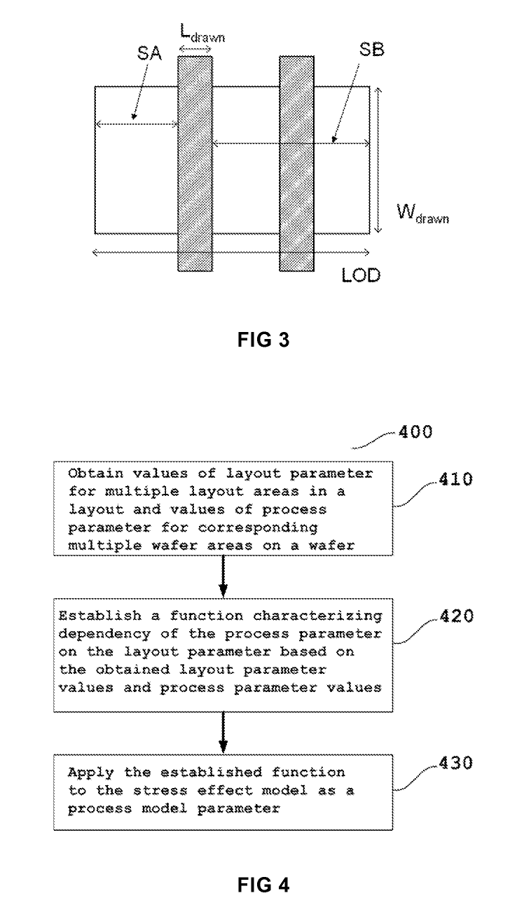

Here, in equation (1), μ_{eff} is the carrier mobility in which the effect of stress (i.e., stress effect) is taken into consideration, μ_{eff0} is the carrier mobility taking no stress effect into account, and thus ρ_{μeff} is the carrier mobility relative change due to stress effect. Equation (2) depicts the dependency of carrier mobility relative change ρ_{μeff} on layout parameters. In equation (2), KU0 is a basic carrier mobility enhancement coefficient for stress effect, which is a process model parameter related to processing and is a constant value under a given process condition; Kstress_u0, Inv_sa and Inv_sb are functions related to layout parameters, such as channel length L_{drawn}, channel width W_{drawn}, SA, SB etc, wherein SA and SB respectively define the distances between the oxide definition (OD) edge to the gate from one side and the other side. FIG. 3 schematically shows a typical physical layout pattern of a transistor, in which layout parameters L_{drawn}, W_{drawn}, SA, SB and LOD (the length of OD) are shown.

The threshold voltage model 140 can be expressed as follows.

$$\begin{matrix}VTH 0 = VTH {0}_{original} + \frac{KVTH 0}{Kstress\_vth 0} \cdot ( Inv\_sa + Inv\_sb - {Inv\_sa}_{ref} - {Inv\_sb}_{ref} ) & ( 3 ) \\ K 2 = K {2}_{original} + \frac{STK 2}{Kstress\_vth 0} \cdot ( Inv\_sa + Inv\_sb - {Inv\_sa}_{ref} - {Inv\_sb}_{ref} ) & ( 4 ) \\ ETA 0 = ETA {0}_{original} + \frac{STETA 0}{Kstress\_vth 0} \cdot ( Inv\_sa + Inv\_sb - {Inv\_sa}_{ref} - {Inv\_sb}_{ref} ) & ( 5 )\end{matrix}$$

Here, VTH0, K2 and ETA0 are the threshold voltage at zero substrate bias, the second-order body bias coefficient, and the DIBL coefficient in subthreshold region having taken into account the effect of stress; and VTH0_{original}, K2_{original} and ETA0_{original} are the threshold voltage at zero substrate bias, the second-order body bias coefficient, and the DIBL coefficient in subthreshold region taking no stress effect into account. KVTH0 is the transistor threshold voltage (VTH) shift coefficient for the stress effect, STK2 is the K2 shift factor related to the VTH0 change, STETA0 is the ETA0 shift factor related to the VTH0 change, which are process model parameters related to processing, and are constant values under a given process condition. Kstress_vth0, Inv_sa, Inv_sb, Inv_sa_{ref} and Inv_sb_{ref} are functions related to layout parameters, such as channel length L_{drawn}, channel width W_{drawn}, SA, SB, etc.

For the stress effect model in the BSIM4 model, reference can be made to BSIM4v4.7 MOSFET MODEL—User's Manual (http://www-device.eecs.berkeley.edu/bsim/Files/BSIM 4/BSIM470/B SIM470_Manual.pdf) for more details, the entirety of which is incorporated herein by reference.

In the stress effect model in BSIM4, process conditions are characterized by process-related model parameters, such as the basis carrier mobility enhancement coefficient KU0 for stress effect. For given process conditions, process model parameters in the model are constant values. However, in practice, with the continuous scaling down of node size, even in the case when the process conditions have been set, process parameters, such as Ge content, SiGe growth rate, SiGe film thickness and so on, may have significant variation. Accordingly, the constant model parameters in the stress effect model under given process conditions can not reflect actual process parameter variation and its influence on the stress.

The inventor has recognized that process parameter variation may be related to layout parameters. Therefore, an optimized stress effect model capable of more precisely simulating device (e.g., transistor) characteristics is disclosed, thereby assisting IC design and fabrication.

It can be seen that in the existing stress effect model of BSIM4, under a given process condition, process model parameters KU0, KVTH0, STK2, and STETA0 are constant values. However, in practice, variation of process parameters inevitably exists. Such variation in process parameters may affect the stress effect, and so setting these process parameters to constant values under a given process condition cannot adequately simulate the effect of stress on transistor performance. To this end, the stress effect model in this disclosure considers the variation of process parameters, which significantly improves the stress effect model. Inventors have found that the variation of process parameters may be related to one or more layout parameters. Thus, in order to reflect the effect of process parameter variation, a process model parameter can be calculated as a function of layout parameter instead of being set to a constant value.

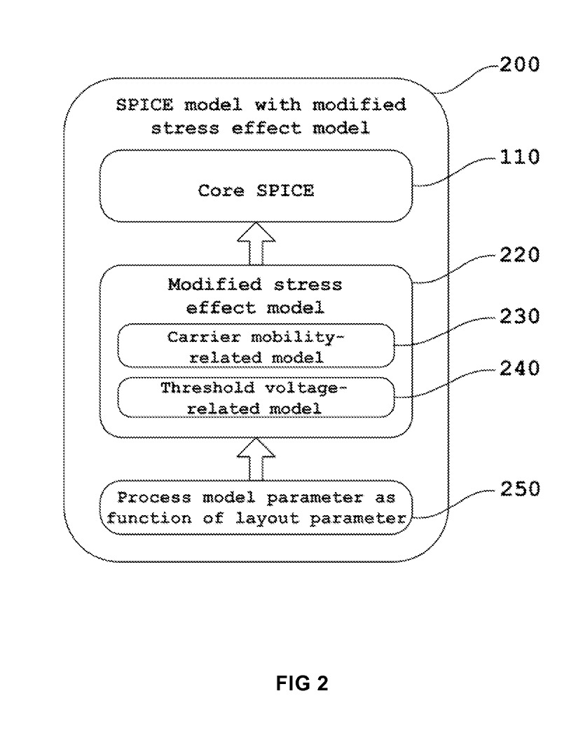

FIG. 2 shows a schematic diagram of a SPICE model 200 with a stress effect model according to an embodiment of this disclosure. As compared to FIG. 1, the stress effect model 120 has been modified in FIG. 2 to have the influence of process parameter variation added therein. Particularly, in the stress effect model 220 of the present disclosure, instead of being a constant value, a process model parameter is calculated as a function of layout parameter (s). Here, the process model parameter may be one or more of KU0, KVTH0, STK2 or STETA0, or may be other process related model parameters, depending on the stress effect model employed.

Below, a method 400 for optimizing a stress effect model in a SPICE model will be described in connection with FIG. 4. The stress effect model uses layout parameters and a process model parameter (e.g., KU0) related to process to evaluate the effect of stress on a transistor parameter. The transistor parameter may include carrier mobility, threshold voltage, and any other simulation parameters representative of transistor performance.

At 410, values of at least one layout parameter for a plurality of layout areas in a layout, and values of at least one process parameter of a plurality of wafer areas on a wafer are obtained.

According to an embodiment, layout parameter values can be extracted from a physical layout pattern, and process parameter values can be measured from a wafer corresponding to the physical layout pattern using a process monitoring tool. The layout parameter may be various geometric parameters that can be extracted from a physical layout. According to an embodiment, the layout parameter may be, for example, silicon coverage, which is defined as, in a given layout area, the ratio of an area where Si is exposed to the given layout area. The process monitoring tool used for wafer measurement may be, for example, secondary ion mass spectrometer (SIMS), transmission electron microscope (TEM), scanning electron microscope (SEM), X ray diffraction (XRD) instrument, etc.

According to an embodiment, the measured process parameter may be, for example, a process parameter involved in a process for applying stress to a transistor (for example, forming an oxide layer in STI, depositing a silicon nitride cap layer with a certain stress, embedding SiGe in a source/drain region, etc). In various stress related processes, the source/drain eSiGe process may significantly improve device performance, and thus has been widely researched and applied. In the so-called eSiGe technique, the source/drain region of a transistor is first etched off, and then a SiGe epitaxial layer is filled through selective epitaxial growth; as a result, stress induced by the SiGe is conducted to the channel to improve the carrier mobility. As for the eSiGe process, the measured process parameter may be, for example, Ge content of the eSiGe, depth of source/drain recess formed through etching, volume of the eSiGe, SiGe growth rate, and thickness of the epitaxial SiGe film, etc.

Note that, at 410, values of multiple process parameters can be obtained. For each process parameter, there are a set of values measured on the plurality of wafer areas. Similarly, values of multiple layout parameters can be obtained. For each layout parameter, there are a set of values extracted from the plurality of layout areas. The number of process parameters and the number of layout parameters can be selected as appropriate, and do not necessarily need to have an association therebetween. Although the dependency of one or more process parameters on a layout parameter is described below as an example, it will be appreciated that the dependency of one or more process parameters on multiple layout parameters can also be evaluated in a similar way.

At 420, based on the obtained set of values for the layout parameter and the obtained set of values for the process parameter, a function that represents the dependency of the process parameter on the layout parameter is established.

For each layout area and wafer area that corresponds to each other, there is a pair of layout parameter value and process parameter value. Therefore, using the pairs of values for the plurality of corresponding layout areas and wafer areas, a function that represents the dependency of the process parameter on the layout parameter can be established through fitting. According to an embodiment, the function is a linear function. According to another embodiment, the function is a semi-logarithmic function. In the case of multiple process parameters, a sub-function characterizing the dependency of each process parameter on the layout parameter can be established, and then a function representative of the dependency of all process parameters on the layout parameter can be obtained by combining these sub-functions.

At 430, the function obtained at step 420 is applied to the stress effect model as a process model parameter. Therefore, in the method 400, even for a given process condition, the process model parameter is not constant; instead, it varies with the variation of the layout parameter as a function of the layout parameter. For different layout areas, the layout parameter may have different values, causing the change of the process model parameter accordingly (meaning that process parameters also vary). Therefore, the stress effect model can reflect the effect of variation of process parameters on transistor performance.

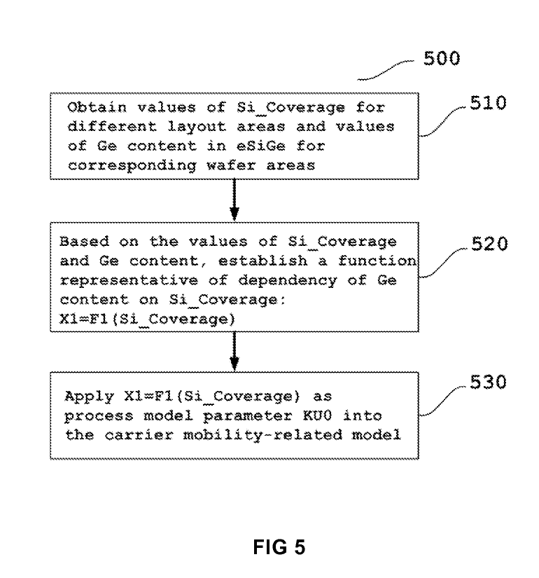

Below, a specific example will be discussed in connection with FIG. 5. In this example, the obtained layout parameter is silicon coverage, Si_coverage, the obtained process parameter is Ge content of SiGe embedded in the source/drain region, and the stress effect model to be optimized is the carrier mobility model shown in equation (2).

FIG. 5 shows a flowchart of the method for optimizing the stress effect model in the SPICE model according to this specific example.

At 510, values of the layout parameter Si_Coverage for different areas in a layout are obtained, and values of Ge content in eSiGe are obtained for the corresponding areas on a wafer.

At 520, based on the obtained Si_Coverage values and the Ge content values, a function representative of the dependency of Ge content on Si_Coverage is established: X1=F1(Si_Coverage). Here, X1 may be Ge content, or may be a model parameter depending on Ge content as demanded.

According to an embodiment, the function F1 may be a linear function, for example:

X1=F1(Si_Coverage)=KUA1·(1+KUB1·(Si_Covergae)) (6)

According to another embodiment, the function F1 may be a semi-logarithmic function, for example:

$$X 1 = F 1 ( Si\_Coverage ) = KUA 1 \cdot ( 1 + KUB 1 \cdot ln ( \frac{1}{Si\_Coverage} ) ) \qquad ( 7 )$$

Here, KUA1 and KUB1 are both fitting coefficients.

At 530, a modified carrier mobility model is obtained by substituting the function X1=F1 (Si_Coverage) into equation (2) for the process model parameter KU0, as shown in equation (8).

$${ρ}_{μ eff} = \frac{F 1 ( Si\_Coverage )}{Kstress\_u 0} \cdot ( Inv\_sa + Inv\_sb ) \qquad ( 8 )$$

The modified model takes the effect of process parameter variation on carrier mobility into account, and thus can simulate device characteristics more precisely.

Similarly, VTH0, K2 and ETA0 in the threshold voltage model can be optimized to make KVTH0, STK2, and STETA0 as functions of a layout parameter, thereby better simulating the threshold voltage characteristics of a transistor.

As an alternative example, in the method 500, the dependency of multiple process parameters on the same layout parameter or different layout parameters can be considered. For example, with respect to the eSiGe process, the respective dependency of Ge content of eSiGe, source/drain recess depth, and SiGe growth rate on Si_Coverage can be considered. Consequently, at 520, the dependency of Ge content on Si_Coverage can be reflected by a sub-function X1=F1(Si_Coverage), the dependency of source/drain recess depth on Si_Coverage can be reflected by a sub-function X2=F2(Si_Coverage), and the dependency of SiGe growth rate on Si_Coverage can be reflected by a sub-function X3=F3(Si_Coverage). Then, these three sub-functions can be combined to get a function representative of the dependency of all these process parameters on the layout parameter. For example, the dependency of these three process parameters on the layout parameter Si_Coverage can be represented as

XX=X1*X2*X3=F1(Si_Coverage)*F2(Si_Coverage)*F3(Si_Coverage).

Thus, at step 530, the function
XX=X1*X2*X3=F1 (Si_Coverage)*F2(Si_Coverage)*F3(Si_Coverage) can be substituted into equation (2) for the process model parameter KU0 to get a new and improved carrier mobility model, as shown in equation (9).

$${ρ}_{μ eff} = \frac{F 1 ( Si\_Coverage ) \cdot F 2 ( Si\_Coverage ) \cdot F 3 ( Si\_Coverage )}{Kstress\_u 0} \cdot ( Inv\_sa + Inv\_sb ) \qquad ( 9 )$$

Note that although the three sub-functions in this example all take Si_Coverage as an argument, they can use different layout parameters as their respective arguments.

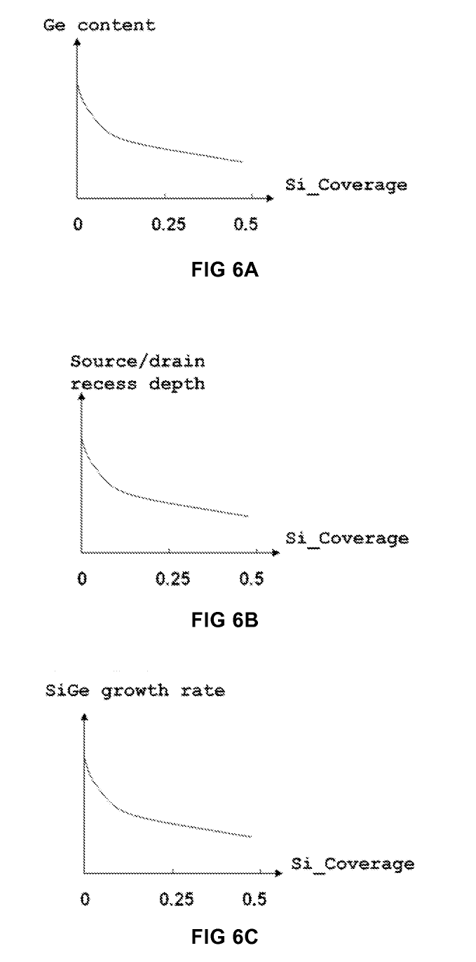

FIGS. 6A-6C schematically show the dependency of the three process parameters on Si_Coverage of the above example, in which Ge content, the values of source/drain recess depth, and SiGe growth rate are obtained through measuring a wafer under a given process condition, and the values of Si_Coverage are extracted from a corresponding physical layout pattern. For the purpose of illustration, instead of specific values, only variation trends of the three process parameters are shown. It can be seen that even under a certain established process condition, these process parameters may vary with the variation of Si_Coverage. Therefore, to improve the stress effect model in the SPICE model the variation of process parameters is included.

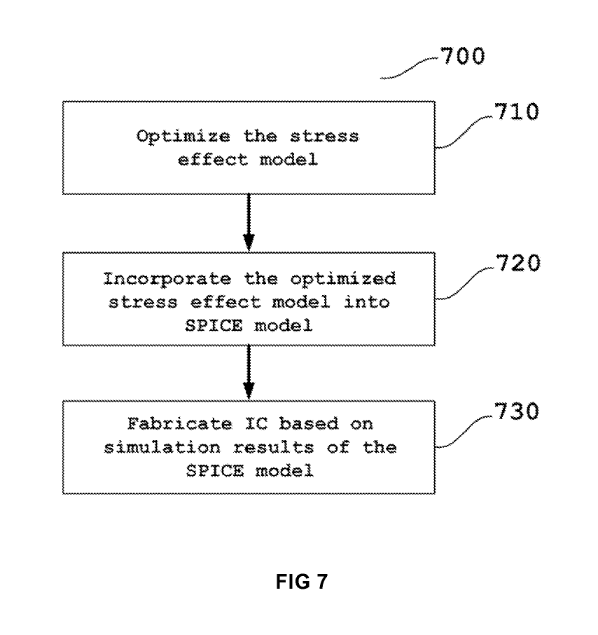

FIG. 7 shows a flowchart of an IC fabrication method 700 according to an embodiment of this disclosure. At 710, a stress effect model is optimized according to the method of an embodiment described above. At 720, the optimized stress effect model is incorporated into the SPICE model. Then, at 730, an integrated circuit is fabricated based on simulation results of the SPICE model.

The above sequence in the method is merely for illustration, and thus unless specified otherwise, the method of this disclosure is not limited to the sequence particularly described above.

The method for optimizing the stress effect model in the SPICE model of the embodiments of the disclosure can be realized through many manners. For example, the method can be realized by software, hardware, firmware or any combination thereof. Further, in some embodiments, the method can be implemented as programs recorded in a record medium, including machine readable instructions for implementing the method of this disclosure. Therefore, those record mediums storing programs for implementing the method of this disclosure are also covered in this disclosure. It should be kept in mind that the disclosure might also cover an article of manufacture that includes a non-transitory computer readable medium on which computer-readable instructions for carrying out embodiments of the method are stored. The computer readable medium may include, for example, semiconductor, magnetic, opto-magnetic, optical, or other forms of computer readable medium for storing computer readable code. Further, the disclosure may also cover apparatuses for practicing embodiments of the method. Such apparatus may include circuits, dedicated and/or programmable, to carry out operations pertaining to embodiments of the method. Examples of such apparatus include a general purpose computer and/or a dedicated computing device when appropriately programmed and may include a combination of a computer/computing device and dedicated/programmable hardware circuits (such as electrical, mechanical, and/or optical circuits) adapted for the various operations pertaining to embodiments of the invention

Those skilled in the art may understand that some or all of the above method embodiments can be implemented by hardware related to program instructions. The program can be stored in a computer readable storage medium, and, when executing, can perform the above method embodiment. The storage medium described above comprises: ROM, RAM, magnetic disc, optical disc, solid state memory and any other mediums capable of storing program code.

Although some particular embodiments of this disclosure have been described in detail with examples, the above examples are merely for illustration but not limitation of the scope of this disclosure. Various modifications can be made to the above embodiments without departing from the scope of this disclosure, including the following claims.

What is claimed is:

1. A method for optimizing a stress effect model in an integrated circuit model, the method comprising:
obtaining values of at least one layout parameter for a plurality of layout areas in an integrated circuit layout;
obtaining values of at least one processing parameter for a plurality of wafer areas corresponding to the layout areas;
based on the obtained values of the layout parameter and the obtained values of the process parameter, establishing a function representative of dependency of the process parameter on the layout parameter; and
applying the function as a process model parameter to the stress effect model.

2. The method according to claim 1, wherein the function is at least one of a semi-logarithmic function and a linear function, and the function is established by fitting the obtained values of the layout parameter for the plurality of layout areas and the values of the process parameter for the plurality of wafer areas.

3. The method according to claim 1, wherein the process parameter is a process parameter involved in a process for applying stress to a transistor.

4. The method according to claim 3, wherein the process parameter is a process parameter related to an embedded SiGe (eSiGe) process.

5. The method according to claim 4, wherein the process parameter comprises at least one of: Ge content of the eSiGe, depth of a source/drain recess, volume of the eSiGe, SiGe growth rate, and thickness of the epitaxial SiGe film.

6. The method according to claim 1, wherein the layout parameter comprises Si coverage, which is defined as, in a given layout area, a ratio of an area where Si is exposed to the given layout area.

7. The method according to claim 1, wherein the values of the layout parameter are extracted from a physical layout pattern and the values of the process parameter are measured using a process monitoring tool from a wafer corresponding to the physical layout pattern.

8. The method according to claim 1, wherein the at least one process parameter comprises a plurality of process parameters, and establishing the function comprises:
for each process parameter, establishing a sub-function representative of dependency of the process parameter on the layout parameter, and
combining the sub-functions for the plurality of process parameters to obtain the function.

9. The method according to claim 1, wherein the transistor parameter comprises at least one of carrier mobility and threshold voltage, and in the case that the transistor parameter comprises the carrier mobility, the process model parameter comprises KU0; in the case that the transistor parameter comprises the threshold voltage, the process model parameter comprises KVTH0, STK2 and STETA0, wherein:
KU0 is a basic carrier mobility enhancement coefficient for stress effect,
KVTH0 is a VTH shift coefficient for stress effect,
STK2 is a K2 shift factor related to VTH0 change,
STETA0 is an ETA0 shift factor related to VTH0 change,
wherein VTH is a transistor threshold voltage, VTH0 is a threshold voltage at zero substrate bias, K2 is a second-order body bias coefficient, ETA0 is a DIBL coefficient in subthreshold region.

10. A system for optimizing a stress effect model in an integrated circuit model, the system comprising:
a processor;
a memory configured to store instructions for controlling the processor, the instructions including:
obtaining values of at least one layout parameter for a plurality of layout areas in a layout of an integrated circuit;
obtaining values of at least one process parameter for a plurality of wafer areas corresponding to the layout areas;
based on the obtained values of the layout parameter and the obtained values of the process parameter, establishing a function representative of dependency of the process parameter on the layout parameter; and
applying the function as a process model parameter to the stress effect model.

11. The system according to claim 10, wherein the function is at least one of a semi-logarithmic function and a linear function, and the function is established through fitting the obtained values of the layout parameter for the plurality of layout areas and the values of the process parameter for the plurality of wafer areas.

12. The system according to claim 10, wherein the process parameter is a process parameter involved in a process for applying stress to a transistor.

13. The system according to claim 12, wherein the process parameter is a process parameter related to an embedded SiGe (eSiGe) process.

14. The system according to claim 13, wherein the process parameter comprises at least one of: Ge content of the eSiGe, depth of source/drain recess, volume of the eSiGe, SiGe growth rate, and thickness of the epitaxial SiGe film.

15. The system according to claim 10, wherein the layout parameter comprises Si coverage, which is defined as, in a given layout area, a ratio of an area where Si is exposed to the given layout area.

16. The system according to claim 10, wherein the values of the layout parameter are extracted from a physical layout pattern and the values of the process parameter are measured using a process monitoring tool from a wafer corresponding to the physical layout pattern.

17. The system according to claim 10, wherein the at least one process parameter comprises a plurality of process parameters, and the instructions for establishing the function further comprises:
instructions for, for each process parameter, establishing a sub-function representative of dependency of the process parameter on the layout parameter, and
instructions for combining the sub-functions for the plurality of process parameters to obtain the function.

18. The system according to claim 10, wherein the transistor parameter comprises at least one of carrier mobility and threshold voltage, and in the case that the transistor parameter comprises the carrier mobility, the process model parameter comprises KU0; in the case that the transistor parameter comprises the threshold voltage, the process model parameter comprises KVTH0, STK2 and STETA0, wherein:
KU0 is a basic carrier mobility enhancement coefficient for stress effect,
KVTH0 is a VTH shift coefficient for stress effect,
STK2 is a K2 shift factor related to VTH0 change,
STETA0 is a ETA0 shift factor related to VTH0 change,
wherein VTH is a transistor threshold voltage, VTH0 is a threshold voltage at zero substrate bias, K2 is a second-order body bias coefficient, ETA0 is a DIBL coefficient in subthreshold region.

19. An integrated circuit (IC) fabrication method, comprising:
using a method for optimizing a stress effect model in an integrated circuit model, the method including:
obtaining values of at least one layout parameter for a plurality of layout areas in an integrated circuit layout;
obtaining values of at least one processing parameter for a plurality of wafer areas corresponding to the layout areas;
based on the obtained values of the layout parameter and the obtained values of the process parameter, establishing a function representative of dependency of the process parameter on the layout parameter; and
applying the function as a process model parameter to the stress effect model;
incorporating the optimized stress effect model into the integrated circuit model; and
fabricating an integrated circuit based on simulation results of the integrated circuit model.
